(19) United States
(12) Patent Application Publication
(10) Pub. No.: US 2005/0126407 A1
(43) Pub. Date: Jun. 16, 2005

(54) Embossing system,components thereof, and methods

(76) Inventors: Natasha P. Hixon, Provo, UT (US); Mark A. Hixon, Provo, UT (US)

Correspondence Address: TRASK BRITT, P.O. BOX 2550, SALT LAKE CITY, UT, 84110, US

(21) Appl. No.: 10/777,994

(22) Filed: Feb. 12, 2004

Related U.S. Application Data
(63) Continuation of application No. PCT/US02/26117, filed on Aug. 15, 2002.
(60) Provisional application No. 60/312,512, filed on Aug. 15, 2001.

(51) Int. Cl. B31F 1/07

(52) U.S. Cl. 101/31.1

(57) ABSTRACT

An embossing die includes a plate and at least one embossing element protruding from a surface thereof. The embossing die may also include at least one cutting edge protruding from the surface of the plate. An embossing system that includes the embossing die may also include a press. The press may be manually operated and may be hand-held or supported upon a flat surface, such as a tabletop. A first member of the press receives the embossing die, while a second member of the press provides support for a sheet of material into or from which the embossing die will form a pattern upon biasing the die against the sheet of material. Manually operated presses and die embossing methods that employ teachings of the invention are also disclosed.

### CROSS-REFERENCE TO RELATED APPLICATIONS

This application is a continuation of PCT Patent Application Serial No. PCT/US/02/26117, filed Aug. 15, 2002, now International Publication No. WO 03/016035 A1, published Feb. 27, 2003, which application claims priority to U.S. Provisional Patent Application Ser. No. 60/312,512, filed Aug. 15, 2001, abandoned.

### BACKGROUND OF THE INVENTION

1. Field of the Invention

The present invention relates generally to embossing equipment for use with sheets of paper, card stock, plastic, fabric, metal (i.e., foil), and the like. More specifically, the present invention relates to embossing systems which include compact dies. The present invention also relates to hand-held die embossers. In addition, the present invention relates to die cutting equipment for use with sheets of material.

2. Background of the Related Art

The use of embossers to form decorative images or to impress seals into sheets of material, such as paper or card stock, is well known. Typically an embosser includes a first, positive die and a second, negative die, which may also be referred to as a “die counter.”

Embossers may be automated or manually operated. An example of a hand-held embosser includes the seal presses that are often used by Notary Publics and other designated officials for applying an embossed seal to certificates or other documents. The die and die counter of such presses are typically not removable therefrom, limiting the utility of such a press for use in forming a variety of different embossed images, designs, or patterns.

Another manually operated embosser is disclosed in U.S. Pat. No. 5,054,389, issued to Kuhlman et al. on Oct. 8, 1991 (hereinafter “the '389 Patent”), and in U.S. Pat. No. 5,181,464, issued to Kuhlman et al. on Jan. 26, 1993 (hereinafter “the '464 Patent”). The embosser of the '389 and '464 Patents is a unitary structure that includes a die and die counter that are secured to one another by way of a so-called “living hinge,” or thinned plastic portion therebetween. As that embosser is a unitary structure, only a single image can be formed therewith. Further, the '389 and '464 Patents do not disclose that the embosser thereof may be used with any other apparatus to facilitate the formation of images in sheets of material or that the embosser could also be used to cut into or through the sheet of material.

U.S. Pat. No. 4,574,693, issued to Fink et al. on Mar. 11, 1986 (hereinafter “the '693 Patent”), discloses another manually operated embosser that is configured to be supported upon a tabletop or other flat surface. The die and die counter of the embosser of the '693 Patent, which appear to be formed from molded plastic, may be removed and replaced with other embossing dies and die counters. One of the die and die counter is positioned relative to a base of the embosser, while the other of the die and die counter is positioned relative to the handle thereof, thereby facilitating movement of the die and die counter toward one another upon biasing the handle of the embosser toward the base thereof. Use of the embosser of the '693 Patent is limited to embossing a sheet of material.

Die cutters have long been used to cut specific shapes from sheets of paper, card stock, and other materials, such as plastic, fabric, metal, and the like. Nonetheless, conventional die cutters are large, expensive machines and, as a result, their availability to individuals has been limited.

An exemplary type of industrial die cutting device includes a thin planar plate member from which a die cutting edge protrudes. The plate member of such a device is typically somewhat flexible to facilitate the assembly thereof with a cylindrical drum which, when rotated, repeatedly cuts the same pattern into a sheet of material. Such an industrial die cutting device may be used, for example, to form windows in envelopes and food packages (e.g., the lids of cylindrical ice cream containers, cookie package windows, etc.). The practical use of such die cutting devices is limited to large-scale commercial production.

Die cutting kits or systems have been made available which include a press and several different dies that may be used with the press. Each die typically comprises a steel rule or cookie-cutter type die that has been formed into a desired shape from a ribbon or strip of metal with a sharpened lower edge. These dies have members that are engaged by the press associated therewith to force the die against and through one or more pieces of paper or card stock to form the desired image therefrom. A spring or other resilient member may also be associated with such dies to facilitate removal thereof from the paper or card stock. In addition, a resilient member, such as a piece of foam rubber, positioned centrally within the die prevents the cut paper or card stock from becoming trapped within the confines of the die. Thus, each such die is part of a somewhat complex die cutting device and, as a result, may be undesirably large. The table-top presses of such die cutting kits or systems are also relatively large. In fact, due to the sizes of these presses and die cutting devices, a briefcase or suitcase sized container is required to store a press and an alphabet sized set (i.e., 26) of die cutting devices.

Further, steel rule dies are formed by bending one or more ribbons or strips of metal into the desired shape. Consequently, the size of image that can be formed with the ribbon or strip of metal is size-limited to a degree that depends upon the thickness of the metal ribbon or strip, as well as on the capabilities of a die forming apparatus. By way of example, conventional steel rule dies typically cannot be used to form letters of the alphabet having a height of less than about one and a quarter (1¼) inches.

At the opposite end of the spectrum, paper punches are relatively inexpensive devices that have long been available to individuals. Paper punches are noncomplex devices that operate on the principle that a male member, which is disposed on one side of a sheet of material, and a female member, which is positioned on the opposite side of the sheet of material, may be biased against one another and against the sheet of material to form a pattern from the sheet. The shapes that may be formed with conventional paper punches are similarly noncomplex, making them somewhat undesirable for use in decorative applications, such as in scrapbooking and creating displays. Moreover, the cuttings formed by paper punches are often undesirably small for use in applications, such as on posters, bulletin boards, or other displays, where visibility from a distance is desired.

As a consequence of the unavailability of conventional die cutting apparatus and the noncomplexity and small sizes of cutting formed by paper punches, individuals who wanted to use letters of the alphabet or other images formed from paper, card stock, or sheets of other materials often had to cut these images by hand.

Recently, punch cut systems which are similar to the above-described die cutting systems, but are intended more for individual consumers have been developed. One type of punch cut system includes a punch with cooperating male and female members. The punch of this type of system is assembled (e.g., screwed into a receptacle of) with a small hand-operated, tabletop press. Examples of this type of system are disclosed in U.S. Pat. No. 5,601,006 to Quinn et al., U.S. Pat. 6,000,139 to Chan, and U.S. Pat. No. 6,089,137 to Lee. Downward (i.e., toward the table) force is applied to a handle of the press to bias the male and female members toward one another and against opposite sides of a sheet of paper to form the desired pattern therefrom. Upward (i.e., away from the table) force is applied to the handle (either manually or by way of a spring or similar mechanism) to remove the male member of the punch from the sheet and to facilitate removal of the formed pattern from the punch and press.

Smaller, individual, thumb-operated punches that include cooperating male and female members that are simultaneously forced through a sheet of paper or card stock are also known in the art. While these hand-operated punches work in a manner similar to the punches of that of the above-described press-operated punches, they require less force to cut paper or card stock.

Nonetheless, currently available hand-operated and thumb-operated punches from which cut paper may be readily removed are typically not capable of forming images with internal holes, such as the internal holes of many letters of the alphabet (e.g., a, b, d, e, g, o, etc.). As with the previously discussed die cutting system, a relatively large amount of space would be required to store an alphabet sized set of these hand-operated punches.

Another type of punch which is configured to form images with internal holes includes a first member with an outer male punch element and an inner female punch element and a cooperating second member with an outer female punch element and an inner male punch element. The inner punch elements of this type of punch are recessed relative to the outer punch elements or vice-versa. In use of this type of punch, the outer punch elements form the outer periphery of a pattern to be cut from a sheet of material, while the inner members form the inner periphery of the pattern. As one of the outer and inner sets of cooperating punch elements is recessed relative to the other to facilitate the formation of a pattern with internal holes, however, the cut pattern typically becomes trapped within such a punch. Consequently, the members of the punch must be pulled away from one another so that the cut pattern may be removed therefrom.

Accordingly, there is a need for a hand-held embossing system in which a plurality of embossing dies may be used to form different images in sheets of material. There is also a need for embossing dies and manually operable embossing systems that may be used to simultaneously emboss an image in a sheet of material and cut into or through the sheet of material.

### SUMMARY OF THE INVENTION

The present invention includes a system for embossing images in sheets of material such as paper, card stock, plastic, foil (i.e., metal), fabric, or the like. The system may also be configured to cut a sheet of material as the sheet is being embossed. An embossing system incorporating teachings of the present invention includes a hand-held, hand-operated press and one or more dies that may be removably assembled with the press, removed therefrom, and replaced with another die.

A die that may be used in the system of the present invention comprises a thin, substantially planar member with a flat back side and one or more embossing elements protruding from a front side thereof. The embossing elements, which protrude a relatively short distance from the front side of the substantially planar member, form a design or pattern that may be reproduced by forming one or more indentations or impressions in a sheet of material. The die may also include one or more cutting edges that protrude from the front side of the substantially planar member and that are arranged in a design or pattern that may be reproduced in sheets of material by cutting into or through the sheets. The material from which the die is formed preferably facilitates repeated use of the die to cut the design or pattern into paper or another material. By way of example only, the die may be formed from a metal such as steel.

Optionally, the die may carry an element, referred to herein as a release element or an ejection element, that prevents an embossed and/or cut sheet of material from becoming trapped within the confines of the embossing or cutting edges. Such a release or ejection element may be formed from a compressible, resilient material (e.g., polyurethane foam or any other suitable material).

An exemplary hand-held, hand-operated press embodying teachings of the present invention includes two opposed, substantially planar members that may be moved toward one another and biased against each other, as well as pulled apart from one another. A first of the opposed members is configured to receive and retain a die in such a manner that the die may be used to emboss and, possibly, cut a design into a sheet of material. A second of the opposed members supports the sheet of material as the first member is being biased against the second member and the embossing elements, as well as any cutting edges, of the die are being forced into or, in the case of cutting edges, through the sheet.

A press according to the present invention may also include a biasing member that is associated with the two opposed members so as to force the opposed members toward one another. Such a biasing member may also be configured to pull the opposed members apart from one another once the desired design or pattern has been formed in or from the sheet of material. In an exemplary embodiment, an actuation member includes two handles that are configured and associated with one another in a manner similar to the handles of pliers. The handles of such an embodiment are pivotally connected to one another such that by moving or squeezing the handles together, the first and second opposed members are forced toward one another, whereas the first and second members are forced apart from each other when the handles are pulled away from one another.

The embossing system of the present invention is particularly useful for individual use in decorating photo albums (i.e., scrap booking), as well as for use in displays (e.g., on poster boards, bulletin boards, and the like) and in other applications.

Other features and advantages of the present invention will become apparent to those of ordinary skill in the art through consideration of the ensuing description, the accompanying drawings, and the appended claims.

### BRIEF DESCRIPTION OF THE DRAWINGS

In the drawings, which illustrate exemplary embodiments of the present invention:

FIG. 1 is a front view of an exemplary embodiment of an embossing die that may be coupled to and used with a press according to the present invention;

FIG. 1A is a cross-sectional view taken along line 1A-1A of FIG. 1;

FIG. 1B is a cross-sectional view of a die with recesses that are complementary to the embossing elements of the die depicted in FIGS. 1 and 1A;

FIG. 2 is a front view of an exemplary embodiment of an embossing and cutting die that may be coupled to and used with a press according to the present invention;

FIG. 2a is a cross-sectional view taken along line 2A-2A of FIG. 2;

FIG. 3 is a side view of an exemplary embodiment of a press of a die embossing system according to the present invention;

FIGS. 3A-3C are partial side views illustrating variations of a first, die receiving member of the press of FIG. 3;

FIG. 4 is a side view that illustrates assembly of a die with the press of FIG. 3;

FIGS. 5-7 are side views depicting use of the assembly of FIG. 4 to form a design in or from a sheet of material;

FIG. 8 is a side view of another exemplary embodiment of a press of a die embossing system of the present invention;

FIG. 9 is a side view of a cradle which supports the press of FIG. 8 upon a flat surface during use of the press; and

FIG. 10 is a perspective view of yet another embodiment of press incorporating teachings of the present invention.

### DETAILED DESCRIPTION OF THE INVENTION

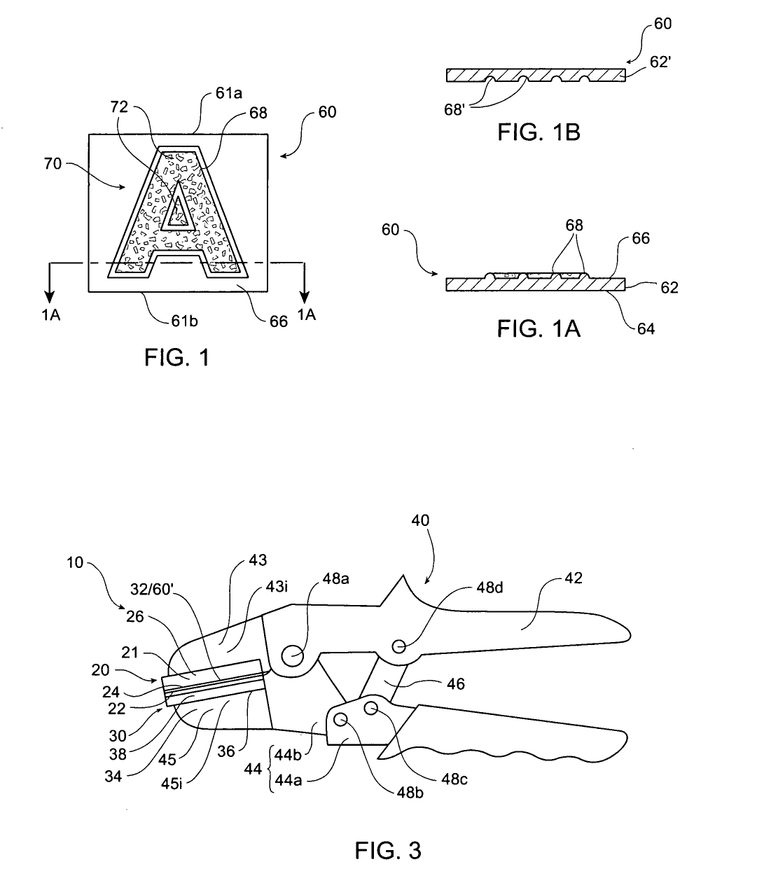

With reference to FIGS. 1 and 1A, an embossing die 60 is illustrated. Embossing die 60 includes a thin, plate 62 with a back side 64 and embossing elements 68 protruding a short distance from a front side 66 of plate 62. Plate 62 may comprise a substantially planar member, with back side 64 being a substantially planar surface thereof. Plate 62 and embossing elements 68 thereof may comprise a substantially unitary structure. Embossing elements 68 forms a design or pattern 70 to be impressed, or embossed, into a sheet of material.

The lateral dimensions of each embossing element 68, as well as the material from which each embossing element 68 is formed, preferably impart embossing elements 68 with the ability to withstand repeated use while minimizing the amount of pressure required for forming an indentation in a sheet of material. The shape of each embossing element 68 may be configured to prevent embossing element 68 from cutting through the sheet of material. As an example and not to limit the scope of the present invention, each embossing element 68 may include rounded edges. The height of each embossing element 68 is sufficient to form indentations in sheets formed from a variety of different types of materials, as well as sheets of a variety of thicknesses. By way of example only, a 0.015 inch embossing element 68 height should be sufficient for forming a visible indentation in most types of card stock, which typically have thicknesses in the range of about 0.010 inch to about 0.015 inch. Of course, the height of an embossing element 68 may be much smaller or larger than the thickness of the sheet of material into which an indentation is to be formed, depending upon the look that is desired for an embossed sheet.

FIG. 1B depicts a receiving die 60′ that is configured complementarily to embossing die 60 shown in FIGS. 1 and 1A and which may be used therewith to form an embossed image in a sheet of material. Receiving die 60′ also includes a plate 62′ with embossing recesses 68′ formed therein. Embossing recesses 68′ are arranged to mirror and configured to receive embossing elements 68 (FIGS. 1 and 1A) of a complementary embossing die 60.

The material and thickness of the remainder of embossing die 60 preferably impart embossing die 60 with desired attributes, such as strength to withstand the force or pressure applied thereto in use and durability to withstand repeated use. Because the pressure applied to embossing die 60 will be localized at embossing elements 68 thereof during use, the thickness and material of the remaining portions of plate 62 are preferably sufficient to impart embossing die 60 with desired amounts of strength and durability.

Embossing die 60 may also include one or more ejection elements 72, which facilitate removal of a sheet of material from locations between adjacent embossing elements 68. By way of example only, ejection element 72 may include a thin sheet of a compressible, resilient material (e.g., polyurethane foam) that has a thickness that, in its relaxed state, is sufficient to force regions of a sheet of material that have become positioned between adjacent embossing elements 68.

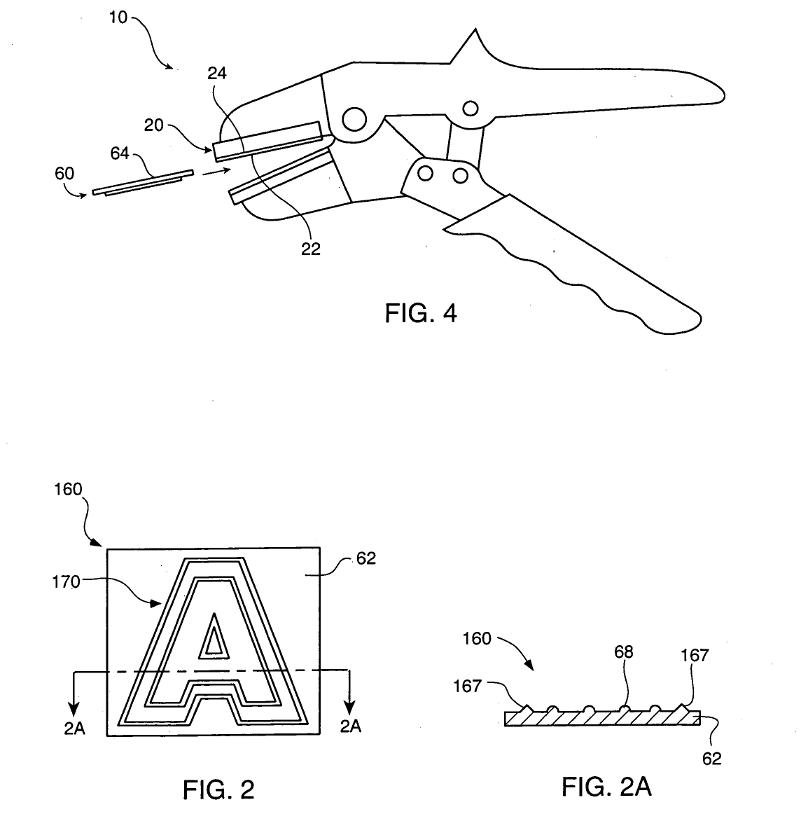

FIGS. 2 and 2A depict another exemplary embodiment of embossing die 160. In addition to embossing elements 68 protruding from a plate 62 thereof, embossing die 160, cutting edges 167 also protrude from plate 62. Embossing elements 68 and cutting edges 167 of embossing die 160 collectively form a pattern 170 if embossing die 160.

The lateral dimensions of each cutting edge 167 and the material from which each cutting edge 167 is formed may impart cutting edges 167 with the ability to withstand repeated use while minimizing the amount of pressure required for cutting into or through a sheet of material. The height of each cutting edge 167 is sufficient to cut into or through sheets formed from a variety of different types of materials, as well as sheets of different thicknesses. By way of example only, a 0.015 inch cutting edge 167 height should be sufficient for cutting through most types of card stock, which typically have thicknesses in the range of about 0.010 inch to about 0.015 inch. In addition, the amount of wear that is endured by both cutting edges 167 and a die supporting member against which cutting edges 167 are forced during use of embossing die 160 should also be taken into consideration when determining an optimal cutting edge 167 height.

Embossing die 160 may also include one or more ejection elements 72, as described previously herein with reference to FIGS. 1 and 1A, to facilitate the removal of sheets of material from between embossing elements 68 and or cutting edges 167.

Embossing elements 68 and cutting edges 167, if any, may be formed by known processes. By way of example only and not to limit the scope of the present invention, chemical mask and etch processes may be employed to form one or more embossing elements 68 and cutting edges 167 on a plate 62, such as a thin sheet (e.g., 30 mils or 0.030 inch thick) of spring steel. One or more masks may be formed over the locations of front side 66 of plate 62 at which embossing elements 68 and any cutting edges 167 are to be located. When a chemical or mixture of chemicals that etches plate 62 is used to form embossing elements 68 and any cutting edges 167, each mask may be formed from a material, such as a suitable photoresist, that will withstand exposure to the etchant chemical or chemicals. Embossing elements 68 and cutting edges 167 may be formed by the use of the same mask and one or more etching processes, or by use of different masks and, thus, different chemical etching processes.

When a photoresist is used as the mask material, a layer of the photoresist may be formed on a surface (e.g., front side 66) of plate 62 and patterned, or exposed and developed, by known photochemical machining processes. Regions of the surface of plate 62 that are exposed through the photomask may then be exposed to a suitable etchant (i.e., an aqueous solution of ferric chloride) to remove material of plate 62 through the photomask and to thereby form embossing elements 68 and/or cutting edges 167. Plate 62 is exposed to the etchant for a duration of time that is appropriate for forming embossing elements 68 and/or cutting edges 167 that protrude a desired distance from the surface of plate 62. The remaining portions of plate 62 are preferably thick enough to impart plate 62 with the desired structural properties (e.g., strength, rigidity, etc.). Thereafter, the etchant may be washed or otherwise removed from plate 62 to ensure that no further etching of plate 62 occurs. The photomask may then be removed from the formed embossing die 60, 160 and any desired additional processes may be conducted, such as teflon-coating of embossing die 60, 160, planarizing back side 64 thereof (e.g., by grinding), or securing one or more ejection elements 72 to plate 62 within the confines of embossing elements 68 or cutting edges 167.

Due to the fine dimensions that may be achieved by use of such processes, design or pattern 70, 170 of embossing die 60, 160 may be smaller or more detailed than the designs or patterns of currently available dies used in embossing or cutting paper.

Similar processes may be used to fabricate receiving die 60′, with regions of a substrate in which recesses 68′ are to be formed being exposed through the mask to facilitate exposure of such regions to a chemical etchant appropriate for the material of the substrate.

As each embossing die 60, 160 is a thin, unitary member, the amount of space consumed by each embossing die 60, 160 is relatively small when compared with the sizes of the currently available paper punch devices. In one embodiment, the overall thickness of an embossing die 60, 160, including the combined thickness of the portion of plate 62 that remains following the etching process (e.g., 0.010 inch or 10 mils) and the distance embossing elements 68 and any cutting edges 167 protrude therefrom (e.g., 0.020 inch or 20 mils), is about 0.030 inch, or 30 mils. Consequently, an alphabet-sized set of 2″×2″ dies 60 may be compactly and portably stored.

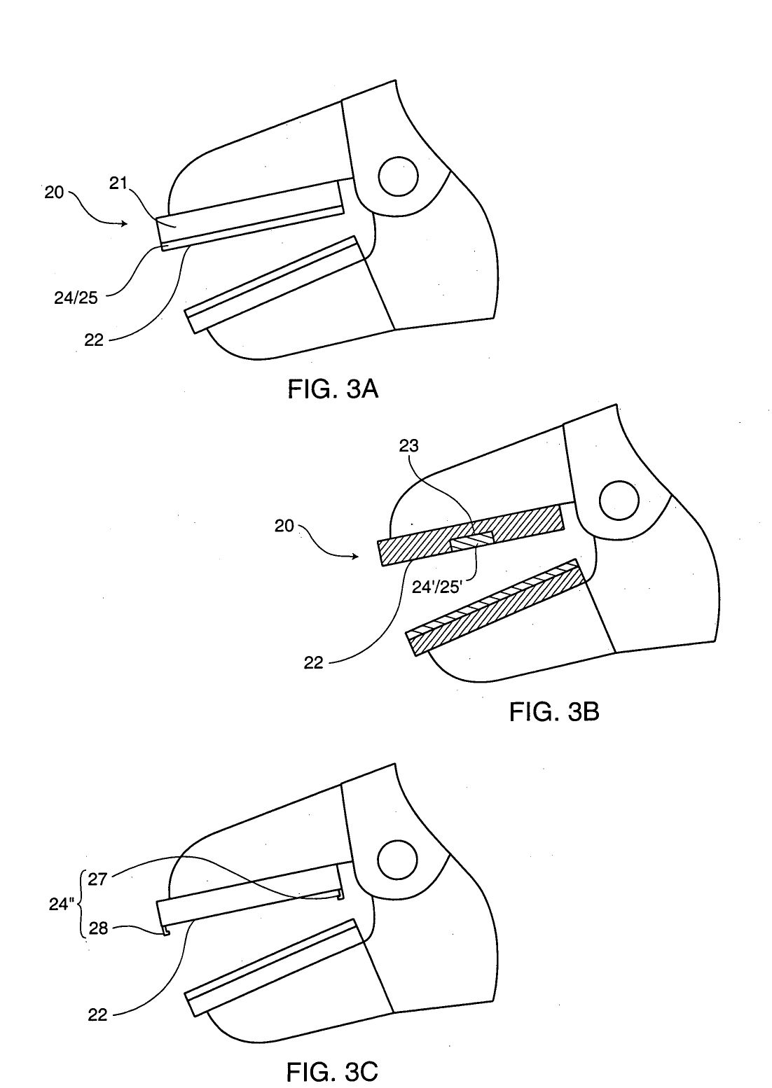

Turning now to FIGS. 3-3C, an exemplary embodiment of a press 10 according to the present invention is depicted.

As depicted in FIG. 3, press 10 is configured to bias an embossing die 60, 160 against a sheet of material in a somewhat radial fashion. Press 10 includes a first member 20, a second member 30 in substantially opposed orientation relative to first member 20, and a biasing element 40.

First member 20 includes a supporting substrate 21, a substantially planar die receiving surface 22, a die retaining element 24 associated with die receiving surface 22, and a connection element 26 located opposite die receiving surface 22. Supporting substrate 21 of first member 20 may rotate in a manner that will facilitate positioning of an embossing die 60, 160 (FIGS. 1, 1A, 2, and 2A) in a plurality of different orientations within substantially the same plane.

Die receiving surface 22, which is substantially planar, is configured to receive back side 64 of embossing die 60, 160. Die receiving surface 22 may receive embossing die 60, 160 in a plurality of different orientations within the same plane. In use, die receiving surface 22 applies pressure to back side 64 of embossing die 60, 160 which pressure is then transferred to embossing elements 68 and any cutting edges 167 of die 60, 160 to force the same into and, in the case of cutting edges 167, possibly through a sheet of material. Accordingly, the dimensions or die receiving surface 22 are preferably adequate to provide support to the entire design or pattern 70, 170 formed by embossing elements 68 and any cutting edges 167 of die 60, 160.

As shown in FIG. 3A, a first example of a die retaining element 24 comprises a substantially planar sheet magnet 25 that is positioned adjacent to and secured to supporting substrate 21 and that forms die receiving surface 22. Die retaining element 24 is useful for securing to first member 20 embossing dies 60, 160 (FIGS. 1, 1A, 2, and 2A) that are formed from materials that are attracted to a magnetic field, such as various types of steel and other iron-containing materials. Upon positioning a magnetically attracted embossing die 60, 160 on or in proximity to die receiving surface 22, the magnetic field generated by magnet 25 draws embossing die 60, 160 toward die receiving surface 22 and secures embossing die 60, 160 on die receiving surface 22.

Alternatively, as depicted in FIG. 3B, die receiving surface 22 of first member 20 may be formed by substrate 21, which also includes a recess 23 formed therein. A disk-shaped magnet 25′ is disposed and secured within recess 23. Magnet 25′ operates by generating a magnetic field into which the material of a complementary embossing die 60, 160 (FIGS. 1, 1A, 2, and 2A) is drawn, thereby pulling embossing die 60, 160 against die receiving surface 22.

As yet another alternative, shown in FIG. 3C, an embossing die 60 (FIGS. 1, 1A, 2, and 2A) may be secured to first member 20 by way of a die retaining element 24″ that includes an L-shaped attachment flange 27 protruding above the plane of die receiving surface 22 and extending partially thereover so as to receive at least an edge 61a of an embossing die 60, 160 positioned on die receiving surface 22. Die retaining element 24″ also includes a movable retention arm 28 that is configured to be positioned so as to engage at least a portion of another, opposite edge 61b of die 60 positioned on die receiving surface 22.

Other alternative types of die retaining elements that may be used on first member 20 include, but are not limited to, the use of adhesive materials or VELCRO to secure an embossing die 60, 160 (FIGS. 1, 1A, 2, and 2A) into position upon die receiving surface 22.

Referring again to FIG. 3, second member 30 of the illustrated embodiment of press 10 is configured to receive and support a support surface 32 or a receiving die 60′, such as that illustrated in FIG. 1B, for receiving a substantially planar sheet of material. Second member 30 may be configured such that a support surface 32 or receiving die 60′ secured thereto may be rotated to a plurality of different orientations within substantially the same plane.

Support surface 32 comprises a support for a sheet of material as an embossing die 60, 160 (FIGS. 1, 1A, 2, and 2A) that has been coupled to first member 20 is being used to form a design or pattern in or from the sheet. Support surface 32 may be formed from a somewhat deformable, somewhat compressible, resilient material to facilitate the receipt of one or more embossing elements 68 as embossing die 60, 160 is biased against the sheet of material and support surface 32. As with die receiving surface 22 of first member 20, the dimensions of support surface 32 are preferably at least as large as the corresponding dimensions of design or pattern 70, 170 of embossing die 60, 160. As a result, when first and second members 20 and 30 are being biased against one another to cut a sheet of material, embossing elements 68 and any cutting edges 167 may be forced into or through the sheet with a substantially uniform amount of force or pressure.

As embossing elements 68 and any cutting edges 167 of embossing die 60, 160 (FIGS. 1, 1A, 2, and 2A) are biased against support surface 32 or receiving die 60′ with a substantial amount of pressure (e.g., as much as about 3,500 pounds per square inch of pressure), support surface 32 may comprise a relatively soft material to prevent damage to embossing elements 68 and damage or dulling of any cutting edges 167. The exemplary, illustrated embodiment of support surface 32 includes a rigid support structure 34 with a cushioning element 38 secured thereto.

Cushioning element 38 may be formed from a substantially rigid material that will also absorb some of the force that is applied by embossing elements 68 and any cutting edges 167 of embossing die 60, 160 to support surface 32 as first and second members 20 and 30 are biased against one another to cut a design or pattern from a sheet of paper, card stock, or another material. By way of example only, cushioning element 38 may be formed from a polymer, such as high density polyethylene, that is softer than the material from which embossing elements 68 and any cutting edges 167 of embossing die 60, 160 are formed. Cushioning element 38 may be secured to support structure 34 by use of a suitable adhesive material, by mechanical fasteners (e.g., nuts and bolts, edge-engaging clips, etc.) or as otherwise known.

An exemplary embodiment of biasing element 40 of press 10 may include two handles 42 and 44 which control the movement of first member 20 and second member 30 toward and away from one another. As in the embodiment shown in FIG. 3, first member 20 and second member 30 may be directly associated with corresponding handles 42 and 44, respectively. Handles 42 and 44 may be connected to one another at a single pivot point, similar to simple pliers.

Alternatively, handles may be configured to provide leverage and increase the amount of force or pressure with which first member 20 and second member 30 are biased against one another. By way of example only, the configuration of lever action pliers available from Knipex-Werk of Wuppertal, Germany (hereinafter “Knipex”), as catalog no. 97 52 14 may be employed as biasing element 40. As depicted, such a biasing element includes a single-member first handle 42, a second handle 44 with a gripping member 44a and a biasing member 44b, and a leveraging member 46 positioned intermediately between and associated with both first handle 42 and second handle 44. First handle 42 may be bent at a location adjacent a first member-connection head 43 thereof. First handle 42 is joined to biasing member 44b of second handle 44 at a first pivot point 48a located proximate first member-connection head 43 and second member-connection head 45 of biasing member 44b of second handle 44. Biasing member 44b of second handle 44 and an end of gripping member 44a thereof are connected at a second pivot point 48b. One end of leveraging member 46 is coupled to gripping member 44a at a third pivot point 48c at a location adjacent to and more central than the position of second pivot point 48b along gripping member 44a. The other end of leveraging member 46 is joined to a central location of first handle 42 at a fourth pivot point 48d.

Support structure 34 of second member 30 of press 10 includes a connection element 36 of a known type (e.g., a weld, braze, or mechanical element, such as one or more rivets or nuts and bolts) by which a position of second member 30 is fixed relative to an interior portion 45i of head 45. First member 20 similarly includes a connection element 26 that couples substrate 21 of first member 20 to an interior portion 43i of head 43.

Of course, alternative embodiments of presses are also within the scope of the present invention. For example, a system according to the present invention may include a table-top press of the type that includes a hand-operated lever for causing a single biasing member to be moved against a back side 64 of a die 60, thereby forcing die 60 against a sheet of paper, card stock, or other material from which design or pattern 70 of die 60 is to be cut.

Referring now to FIG. 4, an example of the assembly of an embossing die 60, 160 with press 10 is depicted. Back side 64 of embossing die 60, 160 is oriented so as to oppose die receiving surface 22 of first member 20 and to be positioned thereagainst. Die retaining element 24 engages embossing die 60, 160, securing the same in position against die receiving surface 22. Embossing die 60, 160 may subsequently be released by die retaining element 24 and removed from die receiving surface 22. Another embossing die 60, 160 or a die of another type (e.g., a cutting die) may then be positioned on and secured to die receiving surface 22.

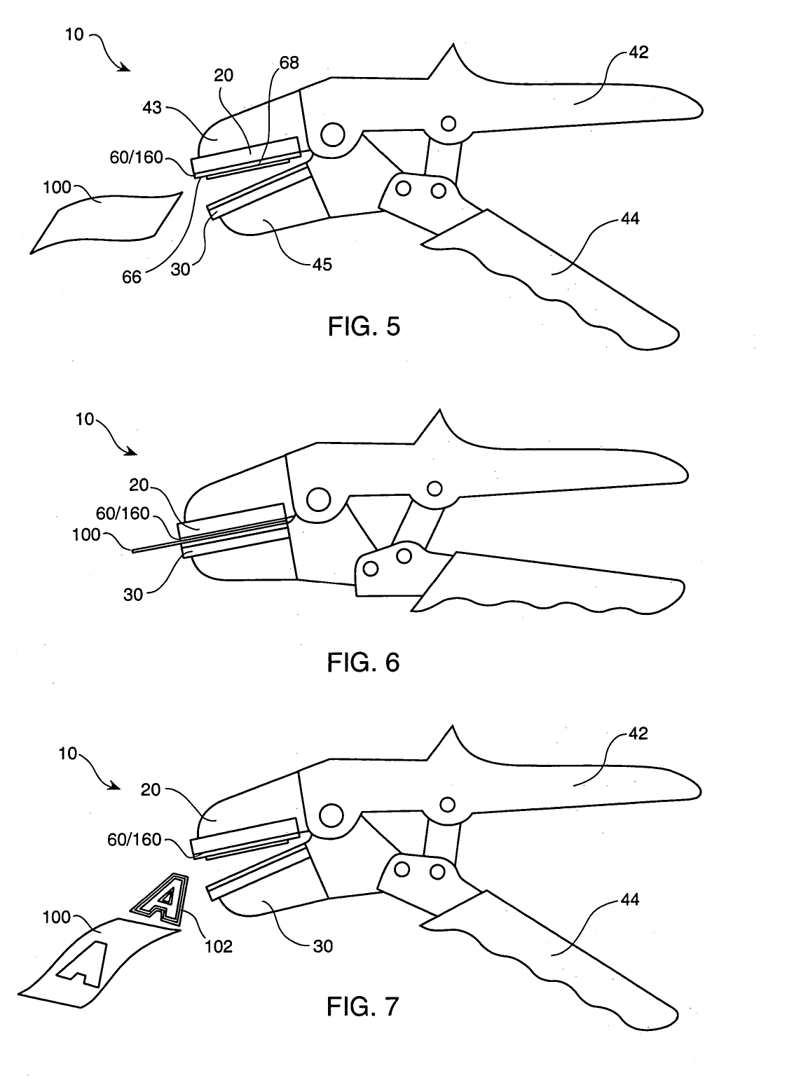

Turning now to FIGS. 5-7, an example of the use of press 10 and embossing die 60, 160 is illustrated.

As depicted in FIG. 5, once an embossing die 60, 160 has been assembled with press 10, one or more sheets 100 of material, such as paper, card stock, foil (i.e., metal), plastic film, or another material may be positioned between front side 66 of embossing die 60, 160, which is secured to first member 20, and second member 30 of press 10. Handles 42 and 44 may then be moved toward one another, in turn, forcing heads 43 and 45 and the respective first and second members 20 and 30 secured thereto toward one another.

When first member 20 and second member 30 are biased against one another with sufficient force, as shown in FIG. 6, each ejection element 72 (FIGS. 1 and 1A), if any, of embossing die 60, 160 (FIGS. 1, 1A, 2, and 2A) is compressed and embossing elements 68 and any cutting edges 167 of embossing die 60, 160 are forced against and into sheet 100 to deform or cut sheet 100.

Next, as illustrated in FIG. 7, first member 20 and second member 30 are forced apart from one another by moving handles 42 and 44 apart from each other. As first member 20 and second member 30 move away from each other, one or more ejection elements 72 (FIGS. 1 and 1A) of embossing die 60, 160 may resiliently expand, ejecting portions of sheet 100 or one or more die cuttings 102 from the confines of embossing elements 68 or cutting edges 167. Die cuttings 102 and any remaining portions of sheet 100 may then be removed from between the first and second members 20 and 30. Press 10 and embossing die 60, 160 may then be used to emboss and/or cut other sheets 100 of material or embossing die 60, 160 may be removed from press 10 and another embossing die 60, 160 or cutting die assembled therewith in place of the first embossing die 60, 160.

While the use of embossing dies 60, 160 is described herein as being aided by use of a press 10, uses of embossing dies 60, 160 without the assistance of a press 10 are also within the scope of the present invention.

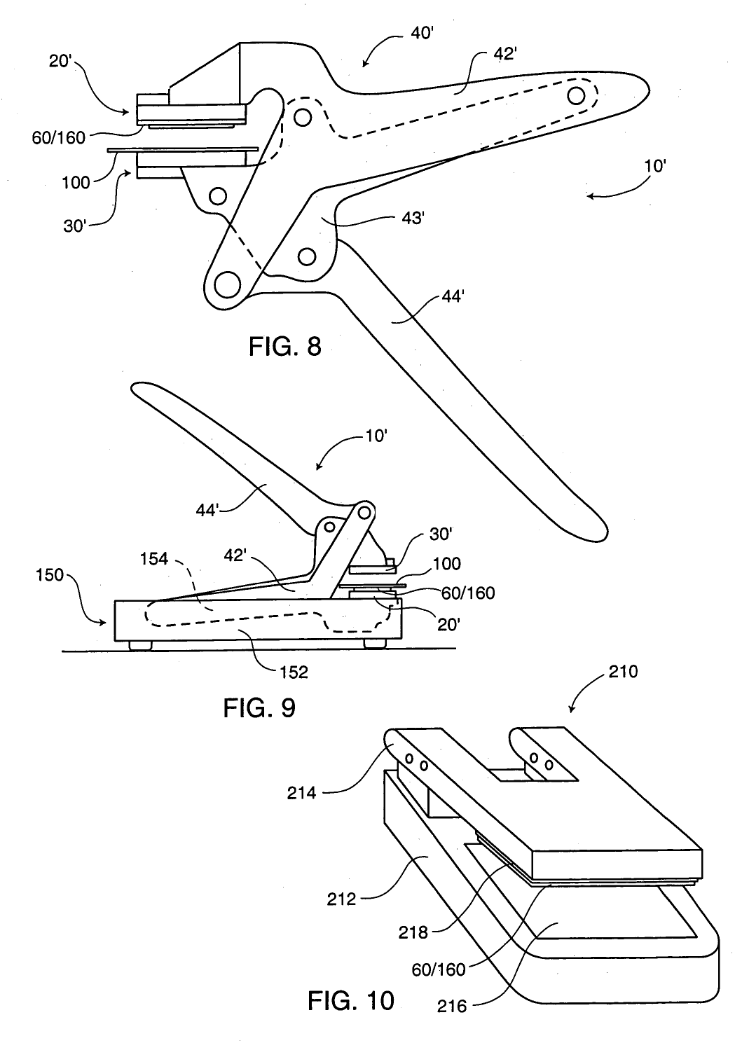

FIG. 8 illustrates another embodiment of hand-held press 10′ incorporating teachings of the present invention. Press 10′, which is configured to bias an embossing die 60, 160 against a sheet 100 of material in a direction that is substantially perpendicular to sheet 100, includes a first member 20′ that receives and retains an embossing die 60, 160, a second member 30′ that supports a sheet 100, and a biasing element 40′ that facilitates movement of first and second members 20′ and 30′ toward and away from one another while maintaining a substantially parallel relation between first member 20′ and second member 30′. Biasing element 40′ includes handle members 42′ and 44+ and an intermediate member 43′ associated therewith that are configured and arranged to maintain the substantially parallel relation of first member 20′ and second member 30′ during movement thereof relative to one another. Such a biasing element 40′ may, for example, comprise the crimp system pliers that are available from Knipex as catalog no. 97 43 200 or those manufactured by Sargent Quality Tools and available as series 4100 and 4200 from Rostra Tool Company of Branford, Connecticut. Press 10′ may be used in a fashion similar to the use of press 10, as depicted in FIGS. 5-7 and described with reference thereto.

Turning now to FIG. 9, a hand-held press incorporating teachings of the present invention (e.g., presses 10 and 10′) may be supported upon a substantially flat surface, such as a tabletop, by way of a cradle element 150. As depicted in FIG. 9, cradle element 150 includes a base member 152 that is configured to be supported upon a substantially flat surface and an opposing receptacle 154 that receives at least a portion of handle 42′ (or handle 44′) of biasing element 40′ of press 10′. Receptacle 154 may also be configured to receive a portion of biasing element 40′ to which either first member 20′ or second member 30′ is secured, as well as a portion of first member 20′ or second member 30′.

Cradle element 150 retains first member 20′ (or second member 30′) of press 10′ in a substantially stationary position as handle 44′ is moved toward handle 42′ and, thus, as second member 30′ of press 10′ and first member 20′ thereof are forced toward one another. Thus, cradle element 150 facilitates the application of pressure by embossing die 60, 160 and second member 30′ to a sheet 100 of paper or another material by way of a downward force rather than by way of the squeezing action that is required when cradle element 150 is not used with press 10′.

Yet another embodiment of press 210 that may be used with an embossing die 60, 160 to form a pattern from a sheet 100 of material is shown in FIG. 10. Press 210 includes a base 212 and a handle 214, or biasing element, that is pivotally associated with base 212.

Base 212 of press 210 is configured to be supported upon a substantially flat surface, such as a tabletop, and to remain in a substantially stationary position upon the substantially flat surface during use of press 210. Base 212 includes a sheet support surface 216 upon which a sheet 100 of paper or other material is held as press 210 is being used with an embossing die 60, 160 to form indentations or impressions in and/or to cut into sheet 100.

A die support element 218, which is configured to detachably receive and retain an embossing die 60, 160 (e.g., as described above with reference to die retaining elements 24, 24′, 24″ depicted in and described with reference to FIGS. 3-3C or otherwise, as known in the art), is associated with handle 214 so as to facilitate the biasing of embossing die 60, 160 against sheet 100 upon movement of handle 214 toward base 212. Likewise, upon movement of handle 214 away from base 212, die support element 218 and, thus, an embossing die 60, 160 secured thereto, moves away from sheet support surface 216 and a sheet 100 of paper or other material positioned thereon.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

1. A portable, hand-held system for forming patterns from a sheet of material, comprising:
a press including first and second members movable toward and away from one another, said first member including a die retaining element associated with a substantially planar die receiving surface thereof; and
at least one die securable to said first member by said die retaining element, said at least one die comprising a thin, unitary member including a plate and at least one embossing element continuous with a surface of said plate.

2. The system of claim 1, wherein said at least one embossing element protrudes from said surface of said plate.

3. The system of claim 1, wherein said press includes a biasing element for moving at least one of said first and second member toward the other of said first and second member.

4. The system of claim 3, wherein said biasing element includes a pair of pivotally connected handles.

5. The system of claim 3, wherein said biasing element includes a handle that moves relative to a substantially stationary base.

6. The system of claim 1, wherein said die retaining element comprises magnetic material.

7. The system of claim 6, wherein at least said plate comprises a material that is attracted to a magnetic field.

8. The system of claim 1, wherein said at least one die comprises steel.

9. The system of claim 1, wherein said die retaining element mechanically secures said at least one die to said die receiving surface.

10. The system of claim 1, wherein said second member includes at least one of a supporting surface and a receiving die secured thereto and oriented to oppose said die receiving surface.

11. The system of claim 10, wherein said supporting surface of said second member comprises a cushioning element.

12. The system of claim 1, wherein said at least one die further includes at least one cutting edge protruding from said surface.

13. The system of claim 12, wherein said at least one die further includes at least one ejection element between adjacent portions of at least one of said at least one embossing element and said at least one cutting edge.

14. The system of claim 13, wherein said at least one ejection element is compressible and resilient.

15. A method for forming a pattern from a sheet of material, comprising:
securing a substantially planar die including a plate and at least one embossing element continuous with a surface of said plate to a substantially planar die receiving surface; and
manually biasing said substantially planar die and a substantially planar sheet supporting surface located opposite the sheet toward one another and against the sheet by grasping handles of a hand-held embossing apparatus and moving said handles toward one another.

16. The method of claim 15, wherein said providing comprises securing said substantially planar die with said at least one embossing element protruding from said surface of said plate to said substantially planar die receiving surface.

17. The method of claim 16, wherein said manually biasing comprises manually biasing said substantially planar die against the sheet and said substantially planar sheet supporting surface including at least one recess formed therein and located correspondingly to said at least one embossing element.

18. The method of claim 15, wherein said manually biasing comprises forcing a member carrying said substantially planar die toward said sheet and said substantially planar sheet supporting surface.

19. The method of claim 18, wherein said forcing includes applying force to at least one handle of a press associated with said member.

20. The method of claim 18, wherein said forcing comprises squeezing two handle members of a hand-held press toward one another.

21. The method of claim 18, further comprising securing said substantially planar die to said member.

22. The method of claim 15, wherein said providing said substantially planar die comprises securing a substantially planar die further including at least one cutting edge to said substantially planar die receiving surface.

23. The method of claim 22, wherein said manually biasing comprises cutting said sheet with said at least one cutting edge.

24. A hand-held system for forming patterns from a sheet of material, comprising:
a hand-held press including first and second members movable toward and away from one another, said first member including a die retaining element associated with a substantially planar, substantially uninterrupted die receiving surface thereof; and
at least one die securable to said first member by said die retaining element, said at least one die comprising a thin, unitary member including a plate and at least one embossing element continuous with a surface of said plate.

25. The hand-held system of claim 24, wherein said at least one embossing element of said at least one die protrudes from said surface of said plate.

26. The hand-held system of claim 24, wherein said second member includes at least one of a supporting surface and a receiving die secured thereto and oriented to oppose said die receiving surface.

27. A method for forming a pattern from a sheet of material, comprising:
securing a substantially planar die including a plate and at least one embossing element continuous with a surface thereof to a substantially planar, substantially uninterrupted, die receiving surface; and
manually biasing said substantially planar die against the sheet and a substantially planar sheet supporting surface located opposite the sheet with a hand-held press.

28. The method of claim 27, wherein said manually biasing comprises squeezing two hingedly connected members of said hand-held press toward one another.

29. The method of claim 27, wherein said manually biasing comprises forming the pattern so as to include at least one embossed portion.

30. The method of claim 27, wherein said manually biasing comprises forming the pattern so as to include at least one cut portion.

31. A portable, hand-held system for forming patterns from a sheet of material, comprising:
a press including first and second members moveable toward and away from one another, said first member including a die retaining element associated with a substantially planar die receiving surface thereof; and
at least one die securable to said first member by said die retaining element, said at least one die comprising a thin, unitary member including a plate, at least one embossing element continuous with a surface of said plate, at least one cutting edge protruding from said surface, and at least one ejection element between adjacent portions of at least one of said at least one embossing element and said at least one cutting edge.

32. The system of claim 31, wherein said at least one embossing element protrudes from said surface of said plate.

33. The system of claim 31, wherein said press includes a biasing element for moving at least one of said first and second member toward the other of said first and second member.

34. The system of claim 33, wherein said biasing element includes a pair of pivotally connected handles.

35. The system of claim 33, wherein said biasing element includes a handle that moves relative to a substantially stationary base.

36. The system of claim 31, wherein said die retaining element comprises magnetic material.

37. The system of claim 36, wherein at least said plate comprises a material that is attracted to a magnetic field.

38. The system of claim 31, wherein said at least one die comprises steel.

39. The system of claim 31, wherein said die retaining element mechanically secures said at least one die to said die receiving surface.

40. The system of claim 31, wherein said second member includes at least one of a supporting surface and a receiving die secured thereto and oriented to oppose said die receiving surface.

41. The system of claims 40, wherein said supporting surface of said second member comprises a cushioning element.

42. The system of claim 31, wherein said at least one ejection element is compressible and resilient.

43. A die for use with a portable system for forming patterns from a sheet of material, comprising:
a thin, unitary member including a plate;
at least one embossing element continuous with a surface of said plate;
at least one cutting edge protruding from said surface; and
at least one ejection element between adjacent portions of at least one of said at least one embossing element and said at least one cutting edge.

44. The system of claim 43, wherein said at least one ejection element is compressible and resilient.

45. The system of claim 43, wherein said at least one embossing element protrudes from said surface of said plate.

46. The system of claim 43, wherein at least said plate comprises a material that is attracted to a magnetic field.

47. The system of claim 43, wherein each of said plate, said at least one embossing element, and said at least one cutting edge comprises steel.
